(19) United States
(12) Patent Application Publication
(10) Pub. No.: US 2005/0089669 A1
(43) Pub. Date: Apr. 28, 2005

(54) Scented polymeric sheet

(75) Inventors: William Sobonya, Westlake, OH (US); Elizabeth Flores, Sheffield Lake, OH (US)

Correspondence Address: Thomas E. Young;Fay, Sharpe, Fagan, Minnich & McKee, LLP, 7th Floor, 1100 Superior Avenue, Cleveland, OH, 44114, US

(73) Assignee: Henkel Consumer Adhesives, Inc.

(21) Appl. No.: 10/693,352

(22) Filed: Oct. 24, 2003

(51) Int. Cl. B32B 3/02

(52) U.S. Cl. 428/95; 428/905; 428/96

(57) ABSTRACT

An improved polymeric layered article or sheet is disclosed that is particularly adapted for use in lining shelves and drawers. The lining sheet preferably contains one or more fragrance emitting agents. The lining sheet may optionally contain a layer of a low tack adhesive along its underside to prevent or minimize slipping between the sheet and the surface to be lined.

### FIELD OF INVENTION

The present invention relates to a scented article in the form of a thin layer which is particularly adapted for lining shelves and drawers.

### BACKGROUND OF THE INVENTION

A variety of household products are known that are scented. In fact, it is often desirable to provide a pleasant fragrance in association with a household product. For example, most cleaning products are scented such that after their use, a pleasant scent or fragrance remains on the surface just cleaned. A wide array of household sprays are also known that are used to provide a pleasurable smell to the interior of a room or house.

Although it would in many instances, be desirable to do so, efforts are generally not taken to apply a fragrance or scent within the interiors of cabinets, closets, or along the surfaces within such small enclosed regions. This is unfortunate since most such regions are unventilated and frequently retain unpleasant odors.

Accordingly, there is a need for an article that readily provides a pleasant scent for small enclosed regions, such as those commonly associated with the insides of cabinets, cupboards, and drawers.

Conventional adhesive sheets, such as adhesive wallpaper or shelving covering, are made from a substrate, such as paper, coated with an adhesive. Positioning such sheets on wall or shelf surfaces, however, is often quite difficult because the sheets cannot be moved once they initially touch the surface. The adhesive that is typically used prevents such movement even after application of only minimal pressure to the sheet.

Adhesive sheets utilizing microparticles dispersed along an adhesive-coated face are known, however, have minimal or no adhesive characteristics when initially applied to a surface. They only adhere to the surface upon application of substantial pressure, which strongly binds the sheet to the surface. The sheet cannot thereafter be repositioned. For this reason, it is very difficult for one person to align such sheets. Also, uniformly distributing microparticles on the surface of adhesive sheets is extremely difficult and/or costly.

Accordingly, there is a need for a lining or covering sheet that securely contacts an underlying surface, yet may be readily repositioned or removed.

As noted, conventional lining sheets are typically formed from paper. Although satisfactory in certain respects, several disadvantages are associated with paper. Paper sheets are subject to decomposition and mold, particularly if used in an environment of high humidity or if they become wet. Similarly, paper materials may crack upon aging or if subjected to dry conditions for prolonged periods.

Accordingly, a need exists for a lining sheet that utilizes a material not prone to the problems associated with paper based lining sheets.

### SUMMARY OF THE INVENTION

In a first aspect, the present invention provides a scented thin layer article adapted to cover an interior household surface. The article comprises a thin layer of a spunbond polymeric material and a scent agent disposed on or incorporated within the thin layer.

In another aspect, the present invention provides a scented sheet adapted for covering a surface. The sheet comprises a thin layer of a spunbond polymeric material. The thin layer defines a first face and an oppositely directed second face. The sheet further comprises an adhesive disposed on the first face of the thin layer. The sheet also comprises a scent agent disposed on or incorporated within at least one of the thin layer of spunbond material and the adhesive.

In still another aspect, the present invention provides a scented thin protective sheet comprising a layer of a spunbond polypropylene, a layer of a low-tack adhesive, and a fragrance emitting composition. The spunbond polypropylene layer has two sides, a first side and a second side opposite from the first side. The adhesive is disposed on the first side of the spunbond polypropylene layer. And, the fragrance-emitting composition is disposed on at least one of the first or second sides of the spunbond polypropylene layer, or the adhesive layer.

### BRIEF DESCRIPTION OF THE DRAWINGS

FIG. 1 is a perspective view of a first preferred embodiment of the present invention.

FIG. 2 is a perspective view of a second preferred embodiment of the present invention.

### DETAILED DESCRIPTION OF THE PREFERRED EMBODIMENTS

The present invention relates to a scented polymeric sheet which finds particular use as a shelf or drawer lining material. This sheet utilizes a thin layer of a polymeric material as the sheet substrate. Preferably, the substrate is a spunbond (sometimes referred to as spunbound) polypropylene. The substrate contains a scent or fragrance emitting agent. The term “scent agent” as used herein includes compositions containing one or more scent or fragrance emitting agents. The substrate may optionally further include a layer of a non-slip, low tack adhesive disposed along its underside. In addition, the substrate may optionally include a paper or film release layer along its underside. As will be appreciated, the release layer may be removed to expose the underside of the substrate, the scent agent, or to expose the layer of adhesive.

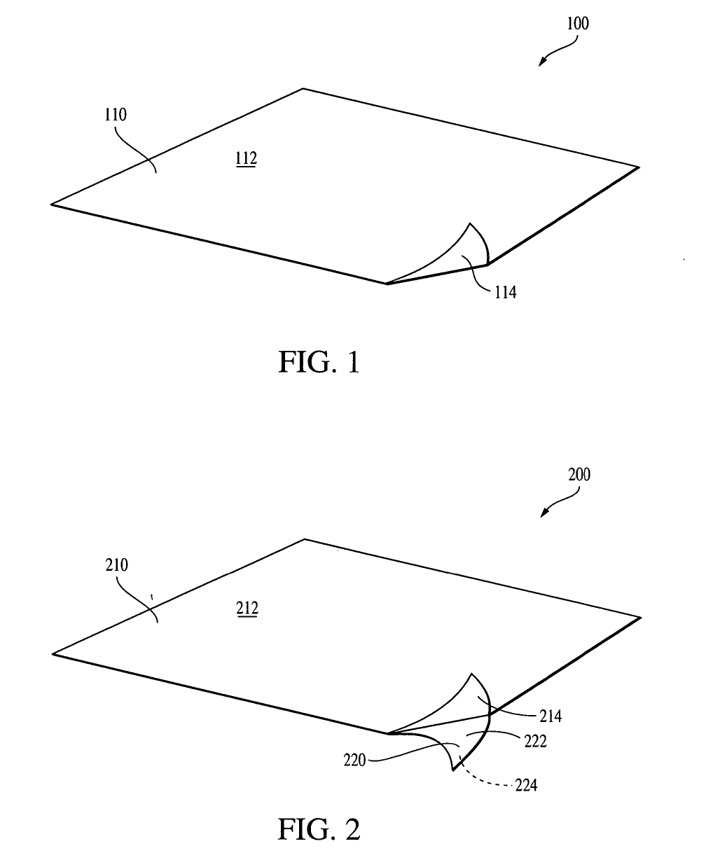

FIG. 1 is a perspective view of a first preferred embodiment of the present invention. Specifically, FIG. 1 illustrates a scented polymeric sheet 100 comprising a base layer 110 which is preferably a polymeric material as described herein. The base layer 110 has a first face 112 and an oppositely directed second face 114. A scent agent is disposed on either of the faces, or both, or may be incorporated in the polymeric material. Optionally, an effective amount of a non-slip, low tack adhesive may be applied along one of the faces of the base layer.

FIG. 2 illustrates a second preferred embodiment scented polymeric sheet according to the present invention. The sheet 200 comprises a base layer 210 and a releasable backing layer 220. The base layer 210 has a first face 212 and an oppositely directed second face 214. The peelable backing layer 220 has a first face 222 and a second oppositely directed face 224. Disposed between the backing layer 220 and the base layer 210 is an effective amount of a non-slip, low tack adhesive. As can be seen in FIG. 2, it is preferred that the second face of the base layer 210, i.e. face 214, faces and is in contact with the first face 222 of the peelable backing layer 220. A scented agent is applied to either of the faces of the base layer, or both faces, or may be incorporated into the polymeric material. In addition, the scent agent may be included in the adhesive. Additionally, a scent agent could be applied to, or incorporated within, the peelable backing layer. In this latter version of the preferred embodiment, since in most uses of the sheet 200 the layer 220 is removed before application of the sheet 200, the materials and their composition and the scent agent are selected so that the scent agent migrates from the backing layer into the adhesive or base layer immediately adjacent thereto.

A wide array of materials may be used for the base layer. As noted, the base layer is formed from a polymeric material. It is preferred to utilize a thin layer of polypropylene for the base layer. Most preferably, the base layer is a spunbond polypropylene.

Spunbond polymeric materials are formed by bonding polymer fibers together to become a single layer of breathable, woven-like material. Specifically, spunbond fabrics are produced by depositing extruded, spun filaments onto a collecting belt in a uniform random manner followed by bonding the fibers. The fibers are typically separated during the web laying process by air jets or electrostatic charges. The collecting surface is usually perforated to prevent the air stream from deflecting and carrying the fibers in an uncontrolled manner. Bonding imparts strength and integrity to the web by applying heated rolls or hot needles to partially melt the polymer and fuse the fibers together. Since molecular orientation increases the melting point, fibers that are not highly drawn can be used as thermal binding fibers. Polyethylene or random ethylene-propylene copolymers are typically used as low melting bonding sites.

In general, high molecular weight and broad molecular weight distribution polymers such as polypropylene, polyethylene terephthalate, polyamide, etc. can be processed by spunbonding to produce uniform webs. Medium melt-viscosity polymers, commonly used for production of fibers by melt-spinning are used. It is most preferred to utilize polypropylene for the spunbond material.

Isotactic polypropylene is the most widely used polymer for spunbond nonwoven materials. It provides the highest yield (fiber per kilogram) and covering capacity at the lowest cost due to its low density. Although unstabilized polypropylene is rapidly degraded by UV light, improved stabilizers permit several years of outdoor exposure before fiber properties deteriorate. To reduce cost, scrap or polypropylene fibers of inferior quality may be reprocessed and then blended in small amounts with fresh polymer to produce first grade spunbond fabrics.

A wide array of commercially available spunbond materials may be used in the lining articles of the present invention. For example, spunbond polypropylene materials may be obtained from Kwang Myung Co., Ltd. of Korea; J.K. Keamey, Ltd., of Framingham, Mass.; and Freshsign of UK.

When utilizing a polymeric spunbond material in the lining sheet of the present invention, it is generally preferred to use a spunbond material having a basis weight in the range of from about 5 to about 800 g/m², and preferably from about 10 to about 200 g/m².

Fiber diameters for spunbond materials typically range from about 1 to about 50 um and are often between about 15 and 35 um.

In certain preferred embodiments, the spunbond material is a composite or laminate of layers. One such preferred composite is a laminate of a first layer of spunbond fibers, a second layer of melt blown fibers, and a third layer of spunbond fibers. The weight proportions of these layers may be varied depending upon the particular end properties desired. However, one particularly preferred laminate has a total weight of from about 3.5 to about 4.1 ounces/yd². Most preferably, this composite includes a first layer weighing about 1.5 ounces/yd² of spunbond fibers, a second layer weighing about 0.8 ounces/yd² of melt blown fibers, and a third layer weighing about 1.5 ounces/yd² of spunbond fibers. The polymeric materials used in each layer may be varied depending upon the application. However, it is preferred to use polypropylene fibers in each layer.

Upon forming the described laminate, the various layers of fibers are adhered together, preferably by ultrasonic welding.

The total thickness of the base layer, or of the laminate if such is employed, including any adhesive if used, is from about 35 to 40 mils. This is generally the preferred thickness of the present invention scented polymeric sheet. The thickness of the sheet will generally be somewhat greater if a release layer is utilized. However, the present invention includes scented sheets having thicknesses greater than or less than this preferred range.

As noted, the preferred embodiment scented sheets may optionally utilize an adhesive that allows positioning of the sheet on a surface and easy registering of the sheet with the surface once appropriately positioned. Once the article has been positioned as desired, it can then be firmly adhered to the surface by applying sufficient pressure to the adhesive along the base layer.

The adhesive layer preferably exhibits low peel adhesion. By this, it is meant that application of a minor amount of pressure to the sheet containing such adhesive does not cause the sheet to substantially adhere, and the sheet can thereafter be easily repositioned. This is accomplished by selecting an adhesive or adhesive composition that exhibits a relatively low tack. Preferably, the adhesive only slightly adheres the sheet to the surface to be covered. Preferably, the adhesive, as residing in the low tack adhesive layer, exhibits a peel adhesion of less than about 0.75 pounds per lineal inch, more preferably less than about 0.2 pounds per lineal inch.

A surface or face of the sheet is at least partially covered with an adhesive layer. The adhesive used in the base layer is preferably a pressure sensitive adhesive. Other adhesives may, however, be used. For example, a wettable adhesive might be used which adheres to a wetted surface.

The adhesive or adhesive composition may contain rheology modifying agents, antioxidants, tackifiers, adhesives, plasticizers, and fillers.

Conventional pressure-sensitive adhesives can be used in the adhesive layer. These can be chosen from among, for example, acrylic adhesives, and rubber resin adhesives.

Acrylic adhesives include, for example, homopolymers, copolymers or crosslinked copolymers of at least one acrylic or methacrylic component, for example acrylic esters such as methyl acrylate, ethyl acrylate, n-propyl acrylate, isopropyl acrylate, n-butyl acrylate, isobutyl acrylate, tert-butyl acrylate, amyl acrylate, hexyl acrylate, octyl acrylate, 2-ethylhexyl acrylate, undecyl acrylate or lauryl acrylate, or as a comonomer, a carboxyl-containing monomer such as (meth)acrylic acid, itaconic acid, crotonic acid, maleic acid, maleic anhydride or butyl maleate, a hydroxyl-containing monomer such as 2 -hydroxyethyl(meth)acrylate, 2-hydroxypropyl(meth)acrylate or allyl alcohol, an amido-containing monomer such as (meth)acrylamide, N-methyl(meth)acrylamide or N-ethyl(meth)acrylamide, a methylol group-containing monomer such as N-methylol(meth)acrylamide or dimethylol(meth)acrylamide, an amino-containing monomer such as aminoethyl(meth)acrylate, dimethylaminoethyl(meth)acrylate or vinylpyridine, or a non-functional monomer such as ethylene, propylene, styrene or vinyl acetate.

Rubber adhesives include, for example, natural rubber, isoprene rubber, styrene-butadiene rubber, styrene-butadiene block copolymer, styrene-isoprene block copolymer, butyl rubber, polyisobutylene, silicone rubber, polyvinyl isobutyl ether, chloroprene rubber and nitrile rubber.

Pressure sensitive adhesives are preferred. Suitable pressure sensitive adhesives for use in the invention are commercially available. A preferred commercially available pressure sensitive adhesive for use as the low tack adhesive layer is Flexcryl™ 1625 (Air Products Allentown, Pa.), which is an acrylic polymer based adhesive. Other preferred commercially available pressure sensitive adhesives for use as the adhesive layer contain Kraton™ D-1107 and Kraton™ D-1102, block copolymers of styrene-butadiene-styrene, styrene-isoprene-styrene, styrene-ethylene-butylene-styrene, and styrene-ethylene-propylene (Shell Chemical Co., Houston, Tex.).

Tackifying agents may be added to the adhesive layer if desired. Such agents are well known in the art. Typical commercially available agents include polyterpenes with softening points from 85-115° C., such as AONESTERT™ (Arizona Chemical, Panama City, Fla.) and PICCOLYTE™ (Hercules, Wilmington, Del.) or C₅ to C₉ hydrocarbon resins such as ESCOREZ™. (Exxon, Houston, Tex.) and WINGTACK™ (Goodyear, Akron, Ohio).

Although the preferred adhesive for use in conjunction with the various scented polymeric sheets described herein is a low tack adhesive, the present invention includes other adhesives. For example, the present invention sheets could utilize a higher tack adhesive. If such a higher tack adhesive is utilized, it is preferred that it can be removed cleanly after contact with an underlying surface.

The low tack adhesive layer preferably has a rough, or contoured, surface caused by the rough underside of the spunbond material. This reduces the surface area of the portion of the lining sheet that contacts the underlying surface. Thus, the thickness of the low tack adhesive layer at any point can vary depending on the underside characteristics or profile of the spunbond material at that point. The thickness of the adhesive layer, measured at the thickest point, is preferably less than about 0.01 inch, and more preferably less than about 0.005 inch. The thickness of the adhesive layer measured at the thinnest point is preferably less than the thickness of the spunbond material.

The adhesive layer and the spunbond layer should preferably be effectively incompatible so that they do not chemically mix or diffuse into one another to any degree that would destroy the individual properties of each layer. The adhesive layer and spunbond layer should not substantially mix prior to the time that the sheet is applied to the surface to be adhered to. Preferably, the adhesive layer diffuses less than about 50% into the spunbond layer, more preferably less than about 20%, most preferably less than about 15%, over a period of two years at room temperature.

If desired, the adhesive layer can be covered with a release layer comprising, for example, a coating containing silicone, or with a peelable release layer, such as silicone coated papers. Such layers are well known in this art. UV 9300 (GE Silicones, Waterford, N.Y.) is one commercially available release layer.

The scent agent may be applied to one or both surfaces of the spunbond material. Or, the scent agent may be incorporated in the polymeric material of the spunbond base layer. Alternatively, or in addition, the scented agent may be included as an additive in the adhesive layer. Moreover, the scented agent may be applied to a release layer generally residing along the exposed face of the adhesive layer.

The scent agent can be applied in nearly any manner, such as by roller or spray application.

The scent agent may be one or more of any commercially available fragrance oils. If the agent is incorporated in a composition, such composition preferably comprises fragrance oil and one or more solvents or diluents. The scent agent may be applied by use of a printing process such as a rotogravure process. The preferred fragrance load is about 0.09 gm/in². The fragrance applied can include, or be comprised of microencapsulated fragrance oil. This will allow for improved shelf life of the scented polymeric sheet.

The evaporation of the fragrance from the sheet can be either enhanced or retarded. Evaporation can be retarded by applying a film of plasticizing agents after the fragrance has been applied to or incorporated within the sheet. Polymers, such as dipropyleneglycol (DPG), diethylphthylate (DEP) or similar solvents, can also be added to the fragrance formulation to thicken the fragrance coating to achieve a heavier coating weight. This will also retard the rate of evaporation of the fragrance from the sheet. Conversely, evaporation enhancers, such as denatured alcohol can be added to the fragrance formulation to increase the rate of evaporation of the fragrance from the sheet.

The scented thin layer article or sheet of the present invention also preferably contains a decorative coloring, indicia, or other markings applied along either of its faces, or both faces. Preferably, a layer of a coloring agent or pigmented composition is applied to one of the faces of the substrate. Alternatively or in addition, indicia, markings or other designs may be applied to the substrate.

The various preferred embodiments of the scented polymeric sheet can be made by conventional means. In one manufacturing process, a roll provides a spunbond polymeric substrate, preferably having a decorative face on the top side of the substrate. The substrate is fed through various idler and tensioning rollers, as is well known by those skilled in the art, where a low tack adhesive material is applied. The adhesive material is dispersed on the bottom face of the spunbond material. An adhesive application roller or slot die may be used to apply a controlled and evenly distributed amount of the adhesive along the bottom surface of the substrate. A scent agent is applied to the substrate. Or, as previously mentioned, the scent agent may be incorporated within the substrate such as, for example, by incorporating such agent in the polymeric material forming the substrate. The coated laminate is dried prior to use.

Although the preferred embodiment lining sheets described herein find particular use for lining or covering shelves or drawers, it is contemplated that the present invention sheets may be used in a wide array of other applications. For example, the present invention sheets may be used as decorative coverings for nearly any surface. The sheets may be used as wallcoverings, wall trim, pictures, posters, stickers, wall hangings, or to provide a decorative or colored surface to appliances, cabinets, walls, ceilings, shelving units, panels, floors, displays, or nearly any other surface.

The foregoing description is, at present, considered to be the preferred embodiments of the present invention. However, it is contemplated that various changes and modifications apparent to those skilled in the art, may be made without departing from the present invention. Therefore, the foregoing description is intended to cover all such changes and modifications encompassed within the spirit and scope of the present invention, including all equivalent aspects.

1. A scented thin layer article adapted for providing a covering for an interior household surface, said article comprising:
a thin layer of a spunbond polymeric material; and
a scent agent disposed on or incorporated in said thin layer.

2. The article of claim 1 wherein said polymeric material is a polyolefin selected from the group consisting of polypropylene, polyethylene, polyethylene terephthalate, polyamide, and combinations thereof.

3. The article of claim 2 wherein said polymeric material is polypropylene.

4. The article of claim 1 wherein said spunbond polymeric material has a basis weight from about 5 g/m² to about 800 g/m².

5. The article of claim 4 wherein said spunbond polymeric material has a basis weight of from about 10 g/m² to about 200 g/m².

6. The article of claim 1 wherein said thin layer of spunbond polymeric material is a laminate of at least two layers of spunbond fibers, wherein said laminate has a total weight of from about 3.5 ounces/yd² to about 4.1 ounces/yd².

7. The article of claim 6 wherein said laminate includes a first layer of spunbond fibers weighing about 1.5 ounces/yd², a second layer of meltblown fibers weighing about 0.8 ounces/yd², and a third layer of spunbond fibers weighing about 1.5 ounces/yd².

8. The article of claim 1 wherein said article has a thickness of from about 35 mils to about 40 mils.

9. The article of claim 1 further comprising:
a layer of an adhesive disposed on said thin layer of said spunbond polymeric material.

10. The article of claim 9 wherein said adhesive is a pressure sensitive adhesive.

11. The article of claim 10 wherein said pressure sensitive adhesive is selected from the group consisting of acrylic adhesives and rubber resin adhesives.

12. The article of claim 9 further comprising:
a release layer in contact with said adhesive layer.

13. A scented sheet adapted for covering a surface, said sheet comprising:
a thin layer of a spunbond polymeric material, said thin layer defining a first face and a second oppositely directed face;
an adhesive disposed on said first face of said thin layer of said spunbond material; and
a scent agent disposed on or incorporated within at least one of said thin layer of said spunbond material and said adhesive.

14. The scented sheet of claim 13 wherein said polymeric material is polypropylene.

15. The scented sheet of claim 13 wherein said thin layer of said spunbond polymeric material has a weight of from about 3.5 ounces/yd² to about 4.1 ounces/yd².

16. The scented sheet of claim 13 wherein said scented sheet has a thickness of from about 35 mils to about 40 mils.

17. The scented sheet of claim 13 further comprising:
a removable release layer in contact with said adhesive.

18. The scented sheet of claim 13 wherein said adhesive is a pressure sensitive adhesive.

19. The scented sheet of claim 18 wherein said pressure sensitive adhesive is selected from the group consisting of acrylic adhesives and rubber resin adhesives.

20. A scented thin protective sheet comprising:
a layer of a spunbond polypropylene, said spunbond polypropylene layer defining a first side and a second side opposite from said first side;
a layer of a low-tack adhesive disposed on said first side of said spunbond polypropylene layer; and
a fragrance-emitting composition disposed on at least one of said first side of said spunbond polypropylene layer, said second side of said spunbond polypropylene layer, and said adhesive layer.
